(19) United States
(12) Patent Application Publication
(10) Pub. No.: US 2014/0317041 A1
(43) Pub. Date: Oct. 23, 2014

(54) METHOD AND SYSTEM FOR PROVIDING CONTEXT AWARENESS BASED NETWORKING OPERATION IN SMART UBIQUITOUS NETWORKS

(71) Applicant: ELECTRONICS AND TELECOMMUNICATIONS RESEARCH INSTITUTE, DAEJEON (KR)

(72) Inventors: Jeong Yun KIM, Daejeon (KR); Gyu Myoung LEE, Gyeonggi-do (KR)

(73) Assignee: ELECTRONICS AND TELECOMMUNICATIONS RESEARCH INSTITUTE, DAEJEON (KR)

(21) Appl. No.: 14/053,812

(22) Filed: Oct. 15, 2013

(30) Foreign Application Priority Data
Apr. 19, 2013 (KR) 10-2013-0043288

(51) Int. Cl. G06N 5/02

(52) U.S. Cl. CPC G06N 5/022
USPC 706/50

(57) ABSTRACT

Disclosed are a method and a system for providing a context awareness based networking operation in smart ubiquitous networks. The present invention provides a network entity with a networking operation that enables dynamically acquiring context information from various sources (for example, an end user, an end user device, a network, a service, and a content) in smart ubiquitous networks, processing, that is, analyzing and deducing related information in the acquired context information, and thereafter, controlling and managing the network depending on the recognized context.

### CROSS-REFERENCE TO RELATED APPLICATIONS

This application claims priority to and the benefit of Korean Patent Application No. 10-2013-0043288 filed in the Korean Intellectual Property Office on Apr. 19, 2013, the entire contents of which are incorporated herein by reference.

### TECHNICAL FIELD

The present invention relates to a smart ubiquitous network. More particularly, the present invention relates to a method and a system for providing context awareness based networking operation in smart ubiquitous networks defined for a smart ubiquitous environment.

### BACKGROUND

With recent development of information and communication technology, the use of a smart device, and the like has rapidly increased, and as a result, the change of a communication network has been required to support various types of services and applications.

ITU-T SG (Study Group) 13 which is an international standard organization has standardized a communication network infrastructure such as a next generation network and in recent years, has developed primary recommendations related to the future networks. The future networks regulated in ITU-T have four objectives and twelve design goals.

Specifically, four objectives are service awareness, data awareness, environmental awareness, and social and economic awareness, and the twelve design goals are service diversity, functional flexibility, virtualization of resources, network management, mobility, reliability and security, data access, identification, energy consumption, optimization, service universalization, and economic incentives.

Presently, a study on future networks has been conducted primarily academia and most studies place emphasis on development of original technology (for example, network virtualization and an identification system) which requires a long period rather than early commercialization. Therefore, in order to counter the problem, a discussion for enabling commercialization at an early stage and urgently introducing a communication network required in a recent smart ubiquitous environment has been in progress.

### SUMMARY

The present invention has been made in an effort to provide a method and a system for providing a context awareness based networking operation in smart ubiquitous networks that can control and manage a network depending on a recognized context after acquiring context information from various sources in the smart ubiquitous networks and processing associated information in the acquired context information.

The present invention first presents an operation required as a core and a function required for the operation in order to support smart ubiquitous networks.

Context information is dynamically gathered from five context sources for accurate context awareness based thereon, the gathered context information is analyzed and deduced, and then a related result is transported to a corresponding network entity so as to be used for another networking operation, thereby implementing the smart ubiquitous networks according to the present invention.

An exemplary embodiment of the present invention provides a method for providing a context awareness based networking operation, including: receiving a query message for performing a specific service and networking operation; analyzing the received query message and checking whether new context information is required from the analyzed query message; when it is judged that the new context information is not required in the checking, acquiring context information related with the analyzed query message; performing context analysis and context prediction based on the acquired context information; judging a networking operation to which the analyzed and predicted context information is to be applied; and transporting a context awareness based networking operation to a corresponding network entity in order to support the networking operation related with the judgment, based on the judgment of the networking operation to be applied.

The method may further include: dynamically acquiring context information from a plurality of context sources and/or a corresponding local agent of each context source; classifying a type of the acquired context information; and storing the acquired context information in a corresponding database (DB) of a context repository in accordance with the type of the classified context information.

The context repository may include an ‘end user DB’, an ‘end user device DB’, a ‘network DB’, a ‘service DB’, and a ‘content DB, and the classified context information may be stored in any one of the DBs in accordance with the type of the context information.

In the acquiring of the context information related with the analyzed query message, the related context information may be acquired from the existing specific database (DB) of a context repository, and the related context information may be dynamically updated from the plurality of context sources and/or (the plurality of local agents to be stored in the specific DB in the context repository.

In the transporting of the context awareness based networking operation, the context awareness based networking operation may include “a context aware content transport capability”, “a context aware programmability capability”, “a context aware smart resource management capability”, “a context aware automatic network management capability”, and “a context aware ubiquity capability”.

The context aware content transport capability may be a networking operation that performs a function to know a current context of a user and transport a related content in accordance therewith.

The context aware programmability capability may be a networking operation that performs an on demand programming function for a service configuration depending on dynamically updated context and policy information from a lower network and each service request.

The context aware smart resource management capability may be a networking operation that performs a function to be aware of a change in a network context considering an aspect of a quality of service (QoS) in various services depending on a policy and a service scenario and perform smart allocation of a network resource by exchanging context information with another network entity.

The context aware automatic network management capability may be a networking operation that performs a function to be aware of a defect by adapting the network to a dynamic situation of the network by managing and monitoring the network using a very economical method without intervention of a person, and diagnose and solve the defect.

The context aware ubiquity (mobility) capability may be a networking operation that performs a function to dynamically secure context information of a mobile entity in order to enable seamless automatic switching between different access technologies and services, and determine a most suitable connection option at a given time by using the same.

Another exemplary embodiment of the present invention provides a context management system that provides a context awareness based networking operation, including: a control and management unit that analyzes a query message for performing a specific service and networking operation, checks whether new context information is required from the analyzed query message, when the new context information is not required, acquires corresponding context information from a repository, and analyzes and predicts the acquired context information, judges a corresponding networking operation to which the analyzed and predicted context information is to be applied; and transports a context awareness based networking operation which is related, to a network entity based on the judgment.

The control and management unit may classify a type of the context information acquired by a context information acquiring unit and store the acquired context information in a corresponding database of a context repository in accordance with the type of the classified context information.

According to exemplary embodiments of the present invention, context information can be dynamically updated in a network context which is complicated and needs support various services.

The dynamically updated context information is analyzed and deduced (predicted) to use a context awareness result in another networking operation, thereby more efficiently and arbitrarily controlling and managing a network so as to be suitable for a smart ubiquitous environment than controlling and managing the network based on the existing static profile information. In detail, a communication network can be intelligently controlled and contents can be efficiently transported, and traffic can be managed by adopting context awareness, resource management, and the like as core capabilities for supporting a “smart” function in the network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating the relationship between a next generation network (NGN) and a future network (FN).

FIG. 2 is a diagram illustrating core capabilities required in a smart ubiquitous network and a function for supporting the same.

FIG. 3 is a diagram illustrating the correlation between a smart ubiquitous network and six core capabilities based on a smart city use case.

FIG. 4 is a conceptual diagram illustrating a smart ubiquitous network structure adopting the six core capabilities according to the present invention.

FIG. 5 is a block diagram illustrating a method of supporting another networking operation by using a context awareness capability in a centralized context management system by using information received from five context sources according to the present invention.

FIG. 6 is a flowchart illustrating an operation of analyzing dynamic context information and applying the analyzed dynamic context information to a smart ubiquitous networking operation in the centralized context management system according to the present invention.

FIG. 7 is one example of a block diagram of the centralized context management system according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The present invention is applied to smart ubiquitous networks. In particular, the present invention is applied to a method and a system for providing a context awareness based networking operation in smart ubiquitous networks. However, the present invention is not limited thereto and may also be applied to all technical fields to which the spirit of the present invention may be applied.

Hereinafter, exemplary embodiments of the present invention will be described in detail with reference to the accompanying drawings. Hereinafter, like reference numerals refer to like elements in the description and the accompanying drawings. Therefore, a duplicated description will be omitted. In describing the present invention, well-known related functions or configurations will not be described in detail since the detailed description for the well-known related functions or configurations may unnecessarily obscure the understanding of the present invention.

Meanwhile, a term “and/or” described in the present invention includes a combination of a plurality of related items or any one item among the plurality of related items.

In a future network suitable for a smart ubiquitous environment, three aspects of a smart end user device, enhanced networking operation, and upgrade of social service are generally required to be considered.

(1) Smart End User Device

Up-to-date smart end user devices having a smart function using ubiquitous connectivity have widely spread in recent years. Examples of the smart end user device may include a smart phone having a multi-connection function and serving as a personal communication and service platform, a smart TV having a bidirectional service feature, and small-sized devices such as a sensor and an actuator which may be mounted on all apparatuses. Since the smart end user device provides various functions which are not provided by the existing user device and has the multi-connection function, a function performed by each smart end user device and a connectable network needs to be considered when the smart end user device provides a networking operation.

(2) Enhanced Networking Operation

The smart end user device and mass contents used by the smart end user device require enhancement of a networking ability of the network. First, various types of media (for example, video or audio) having different service quality requirements are required to be supported and the contents are required to be efficiently transferred while considering seamless handover among different devices. Efficient processing of different data traffic from a small volume to a high capacity, and fair allocation and management of a network resource are required. Therefore, enhancement of the networking operation needs to be considered to satisfy the requirements.

(3) Upgrade of Social Service

With the advent of an advanced information society, strong security and improved convenience are required as a core feature of a social service. More convenient living is required to be provided to a user by constructing service infrastructure such as a smart city is constructed by using the network while protecting a daily life through a high-level security service that solves security weakness.

Viewpoints which the future network needs consider in the smart ubiquitous environment may be summarized as a feature called “smart” and versatility called ‘ubiquitous”. That is, the future network includes directionality to be developed to a network which may be used by any apparatus whenever or wherever without distinguishing a communication target by using the feature called “smart” and the versatility called “ubiquitous”.

Therefore, the future network is required to enhance a function to more efficiently use network information, service information, and end user device information in addition to traditional connectivity providing and information transferring functions than the existing network in order to support the smart ubiquitous environment. Therefore, ITU-T SG13 defines a smart ubiquitous network (SUN) as a near-term realization of future network.

Hereinafter, technical terms described in the present invention will be described in brief.

“The smart ubiquitous network (SUN)” is an IP based packet network that supports various categories of services between a person and an object. The service provided by “the smart ubiquitous network” includes a control service, a processing service, and a storage service. Herein, “smart” means a knowledge based, context awareness, adaptive, automatic programmable, efficient, and safe network. “Ubiquitous” means a network accessible whenever and wherever by using multi-types of access technologies, which includes the end user device and a person-apparatus interface. A core goal of “the smart ubiquitous network” is to extend a networking operation of an IP based network by optimally and efficiently using various types of resources by considering interobject (i.e., object-to-object) communication as well as interperson (i.e., person-to-person, person-to object) communication.

The present invention allows the smart ubiquitous network to support various types of information terminals, and to perform a networking operation essentially required to provide a new service using the same and a context awareness based networking operation using dynamically changed “context information”.

A basic concept of the present invention is to acquire context information from various sources (resources) in the smart ubiquitous network, process related information in the acquired context information, and provide a networking operation to a network entity so as to control and manage the network according to a recognized context.

The aforementioned and additional aspects of the present invention will be clearer through exemplary embodiments described with reference to the accompanying drawings. Hereinafter, the present invention will be described in detail so as to be easily understood and reproduced by those skilled in the art through the exemplary embodiments.

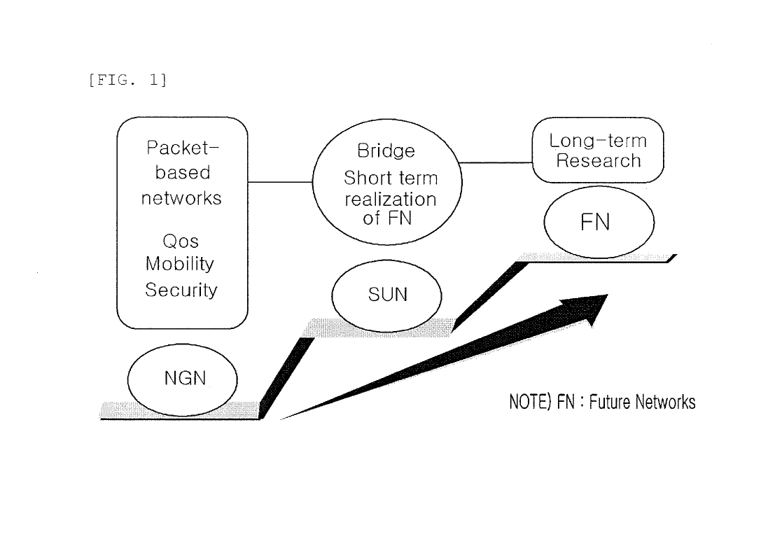

FIG. 1 is a diagram illustrating the relationship between a next generation network (NGN) and a future network (FN).

As illustrated in FIG. 1, “a smart ubiquitous network (SUN)” is a bridging technology that considers function extension of the existing next generation networks (NGNs) while pre-implementing the future network (FN).

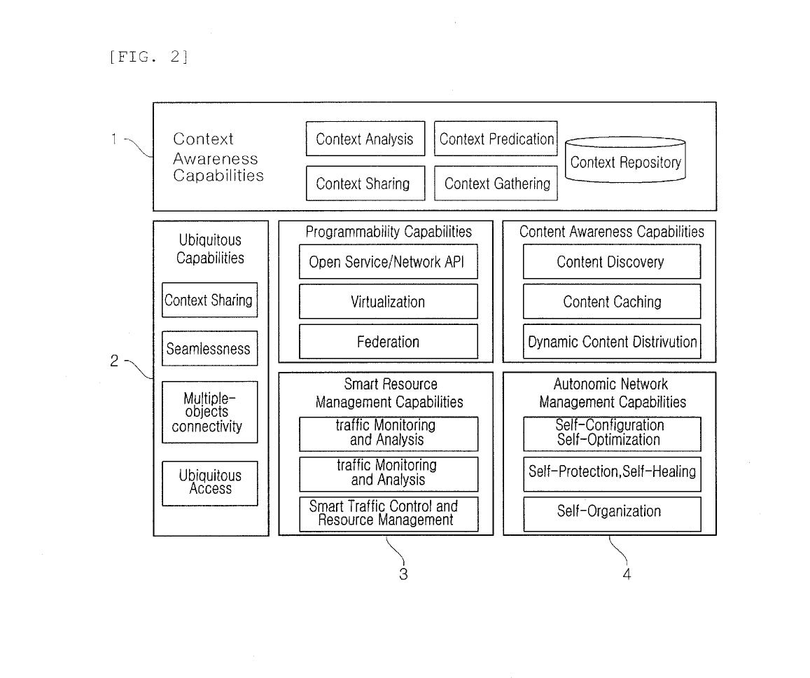

FIG. 2 is a block diagram illustrating a core capability required in the smart ubiquitous network and a function for supporting the core capability. In the block diagram of FIG. 2, a concept for six core capabilities is illustrated in order to satisfy requirements of “the smart ubiquitous network (hereinafter, referred to as ‘SUN’ for convenience)”. A context awareness capability 1, a ubiquitous capability 2, a smart resource management capability 3, an automatic network management capability 4, a programmability capability 5, and a content awareness capability 6 are required. Meanwhile, terms of the aforementioned six core capabilities are just defined for convenience in order to describe the exemplary embodiments of the present invention, in order to describe a functional operation of the smart ubiquitous network, and the present invention is not limited to the meaning of the terms themselves.

Hereinafter, six core capabilities of “the smart ubiquitous network (SUN)” illustrated in FIG. 2 will be described.

First, “the context awareness capability” is an operation in which the network may sense a change in a physical state from a device. For example, a monitoring system using sensor and location based services supports context awareness. In particular, “the context awareness capability” allows the network to monitor a change in a context adaptively to a feature and an environment of a user by dynamically gathering context information. Meanwhile, information for context awareness may also be used to support another operation such as context aware content delivery.

“The content awareness capability” is an operation in which the network may efficiently identify, search, and transfer the contents based on content related information considering the position and the user. “The content awareness capability” provides a personalized content transferring service based on a context of each user or an optimized content transferring service. Meanwhile, information for content awareness may also be used for another operation. That is, for example, the information for content awareness may be used for another operation such as content aware smart resource management that reduces inefficient transferring of the network presently which simply occurs due to retransmission without knowledge regarding the contents, and considers enormously increased hosts and enormous contents having a positional dependent relationship with the hosts.

“The programmability capability” means an operation to change software, a feature, and a function of the network by changing a program of the network. “The programmability capability” enables a new and simple network service to be developed and applied. “The programmability capability” allows the network to form a virtualized network by using a related resource capable of supporting a service according to an opened interface.

“The programmability capability” is an operation for close cooperation between the service and a transferred function at the time of forming the virtualized network using a resource related with resource level information exchange in order to support a specific service network.

“The smart resource management capability” is an operation to support transparent and accurate processing of various types of resources (for example, a bandwidth, a storage, and computing power) in the network, and fair use of the resources through management of the resources. A service to be developed in the future requires efficient bandwidth allocation to multiple TCP flow and UDP in the network and the reason is for a host or an application to fairly use the resources by considering service delegation and a service defect.

“The automatic network management capability” is a dynamic and arbitrary adaptation operation of a system related with the network according to an operational condition and an operation state of the network, which include a user's economic and social requirements. By “the automatic network management operation”, the corresponding network may monitor a defect of the network itself, sense and diagnose, and solve the sensed and diagnosed defect according to a related policy in an arbitrary networking environment.

“The ubiquitous capability” is an operation that provides seamless communication between persons, between the person and the object, or between the objects while the person and the object move from a predetermined location to another place. In particular, “the ubiquitous capability” may actively handle changes in the device and environment through interaction between the person and the object in the ubiquitous environment in order to provide a desired service whenever and wherever. “The ubiquitous capability” supports handover and roaming, and continuity of the service between the networks.

Hereinafter, as illustrated in FIG. 2, main function required to support the aforementioned six core capabilities are specified.

(1) Main functions required to support the context awareness capability will be described below.
Context gathering is to gather context information from distributed entities (e.g., an end user, an end device, a network entity, and a time for time information).
Context repository is to store the generated context information or search the information as necessary.
Context analysis is to perform a function to analyze the context information, provide statistical information, and convert the information into an available format in order to appropriately use the information.
Context prediction is to perform a prediction function for previously preparing a context which will occur in the future through the context information analysis.
Context sharing is to perform a function to safely transfer and update the context information to each entity requiring the context information.

(2) Main functions required to support the content awareness capability will be described below.
Content discovery is to perform a process of discovering a most suitable content and a most suitable content storage by using user's positional information or metadata information of the content.
Content caching is to store and cache the content in a local storage.
Dynamic content distribution is to dynamically distribute a cache in the network and a content in the storage depending on a QoS and a traffic load considering traffic optimization, a use pattern, and a user's position.

(3) Main functions required to support the programmability capability will be described below.
Open service/network APIs are to develop and provide the service and a related service in terms of the network through an interface standardized according to the requirement, and support related monitoring and controlling operations.
Virtualization is to enable abstraction of a partition of a resource logically separated from a physical resource on aggregation of a shared physical network infrastructure and multiple resources.
Federation is to interconnect interdomain networks by determining an interface for internetwork control, service routing, log-in, charging, and metadata and providing the determined interface.

(4) Main functions required to support the smart resource management capability will be described below.
Smart resource monitoring is to verify the network entity and the resource of the interface in order to optimally allocate the resource.
Smart resource analysis is to determine an appropriate resource for each user and service based on a policy related with monitoring data.
Smart resource control is to allocate an appropriate resource for each flow, user, and service.

(5) Main functions required to support the automatic network management capability will be described below.
Self-configuration is to automatically configure a network component without manual intervention.
Self-optimization is to automatically monitor and reallocate the resource in order to achieve a functional operation optimized to a predetermined requirement (for example, a predetermined policy for energy consumption).
Self-protection is to previously sense a predetermined attack such as changing and opening information related with an individual network, and prevent the previously sensed attack.
Self-healing is to automatically sense, diagnose, and recover a defect caused by a power problem, a functional failure due to a specific software bug, and the like.
Self-organization is to automatically reset connection depending on topology and a location in which data may be transferred and aggregated.

(6) Main functions required to support the ubiquitous capability will be described below.
Adaptedness is to support a dynamic change in a communication environment with assistance of context awareness.
Seamlessness is a function such as mobility in different domains and layers, for example, user/device mobility, network mobility, service mobility, and content mobility.
Multiple-object connectivity is various types of communication support functions between objects as well as persons.
Ubiquitous access is a function for a content to access the network regardless of the location as well as heterogeneous and multiple interfaces under a wired/wireless environment.

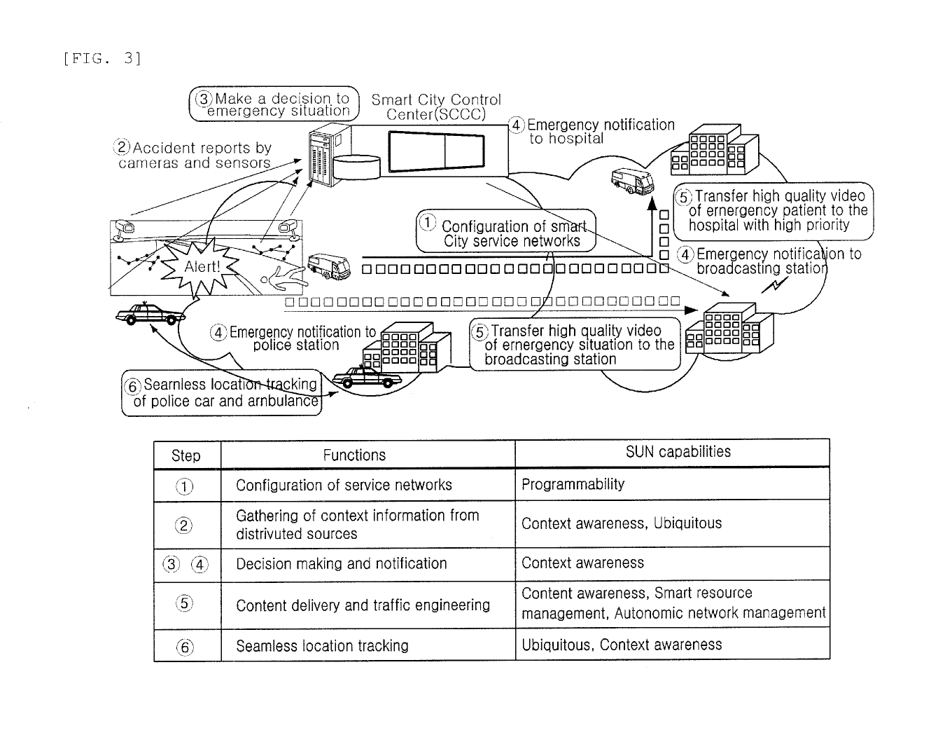

FIG. 3 is a diagram illustrating the correlation between the smart ubiquitous network and the core capabilities of FIG. 2 based on a smart city use case.

FIG. 3 is an exemplary embodiment describing how the smart ubiquitous network operates in a smart city. In particular, various cases requiring smart communication supporting various types of connections may be considered, and FIG. 3 illustrates analysis of a specific use case for more detailed appreciation for the smart ubiquitous network. Respective steps of FIG. 3, that is, Step \textcircled{1} to Step \textcircled{6} will be described below.
Step \textcircled{1}: The network is automatically configured in order to support the service of the present invention according to a smart city service subscription request.
Step \textcircled{2}: It is assumed that a traffic accident occurs with a vehicle in the smart city. As a result, it is assumed that a vehicle driver of the traffic accident vehicle is significantly injured and two passengers (for example, passenger A and passenger B for convenience) suffer minor injuries. In this case, it is assumed that the vehicle driver uses an e-health service with a vehicle mounted with an intelligent transport system (ITS). It is assumed that passenger A uses the e-health through a mobile phone while wearing an e-health monitoring jacket. It is assumed that the mobile phone possessed by passenger A is out of a communication region of a mobile service provider. In this case, when the traffic accident vehicle is positioned on a road connected with the ITS, the traffic accident is detected so as to be notified to “a smart city control center (SCCC)”. Alternatively, since the accident vehicle is a vehicle having the ITS function, the traffic accident may be detected through a camera and a sensor mounted on the vehicle to be notified to the smart city control center (SCCC).
Step \textcircled{3}: “The smart city control center (SCCC)” receives the traffic accident, analyzes a material acquired in association with the traffic accident, and then judges this situation as an emergency situation.
Step \textcircled{4}: Notification associated with the traffic accident and the emergency situation is transferred from the SCCC to another organization. That is, for example, information associated with the case (that is, the traffic accident) may be notified to other organizations such as a close police station for processing the emergency situation such as a person, a vehicle, and traffic associated with the traffic accident, a hospital where patients are present in order to verify states of the patients, and a broadcasting station associated with the traffic accident in order to notify a current situation including an accident video.
Step \textcircled{5}: A high-definition video image (alternatively, a moving picture) is reliably and preferentially transmitted to the hospital. A high-definition video image (alternatively, moving picture) of the patient (driver) which is under the emergency situation, for example, a record associated with the patient's health is transmitted to the hospital. Meanwhile, a current health state of patient A (that is, passenger A) acquired from the e-health jacket may be connected with another mobile provider through an emergency mode of the mobile phone when a mobile phone of patient A is aware of the accident situation of the traffic accident, and the mobile phone of patient A may be transmitted to a high-definition image associated with the traffic accident to the hospital or the broadcasting station. Meanwhile, general information acquired from a social profile associated with a mobile phone of patient B (that is, passenger B) may be transmitted to the hospital from patient B.
Step \textcircled{6}: Meanwhile, a seamless service is enabled through position tracking while the vehicle moves. Hereinafter, the correlation between the core function of each step and the smart ubiquitous networking operation for supporting the core functions, which is mapped with the core function of each step of FIG. 3 will be described below.

Step \textcircled{1} is mapped to “the programmability capability” as a configuration of the service network.

Step \textcircled{2} performs a function to gather context information from distributed sources and is mapped to “the context awareness capability” and “the ubiquitous capability.”

Step \textcircled{3} and Step \textcircled{4} perform a function of decision making and notification, and are mapped to “the context awareness capability”.

Step \textcircled{5} performs content delivery and traffic engineering, and is mapped to “the content awareness capability”, “the smart resource management capability”, and “the automatic network management capability”.

Step \textcircled{6} performs a seamless location tracking function, and is mapped to “the ubiquitous capability” and “the context awareness capability”.

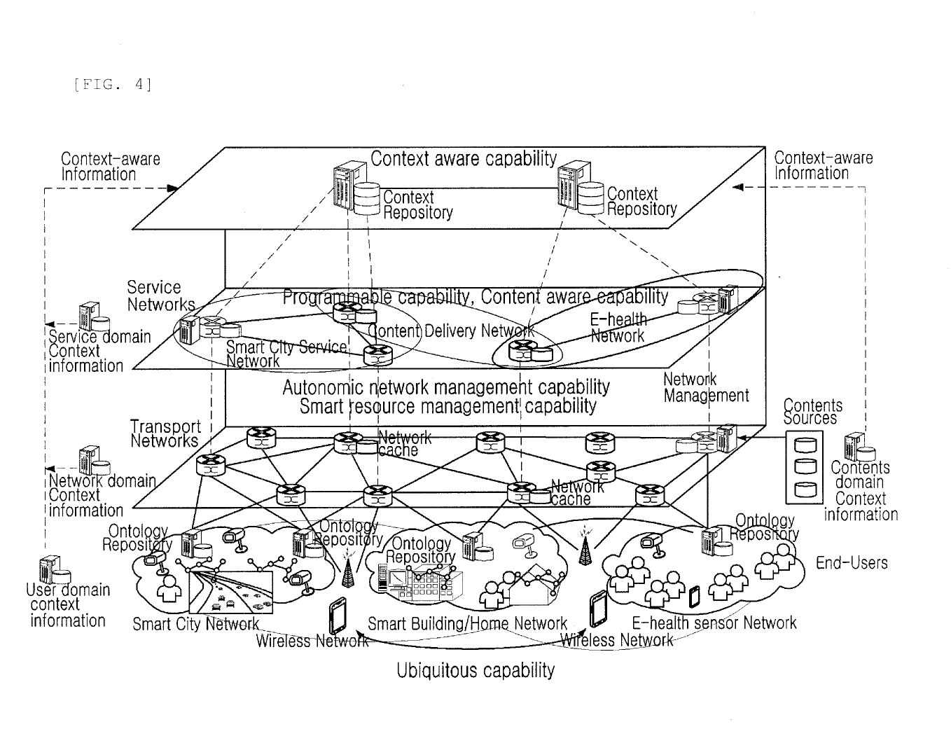

FIG. 4 is a conceptual diagram illustrating a smart ubiquitous network structure adopting six core operations according to the present invention.

As illustrated in FIG. 4, “the smart ubiquitous network structure” according to the present invention is constituted by three domains. That is, the three domains defined in FIG. 4 include a transport network domain, a service network domain, and an end user domain. Each of the domains may be constituted by an entity of the smart ubiquitous network (SUN). Herein, the entity may be implemented as a physical component of the network, and may be implemented by a module including one or more software programmed to perform a specific corresponding function and one or more hardware (for example, a motor, a semiconductor, a microprocessor, a memory chip, and the like). The entity may be a microprocessor recorded with a program to perform a specific subsequent method. The entity corresponds to a comprehensive meaning including a device configured by a physical component which can be implemented.

Hereinafter, the three domains defined in FIG. 4 will be described in detail.

Transport Network Domain Entity

The transport network domain entity of the smart ubiquitous network (SUN) performs processing of traffic and related resources so as to enable smart resource management and automatic network management. Some transport nodes have a network cache so as to efficiently and effectively transport the content.

Service Network Domain Entity

The service network domain entity of the SUN forms an overlay network with respect to respective specific services and applications (for example, a smart city network, a content transport network, and an e-health network). The service network domain entity may also perform an operation for supporting better services and applications by the network management and smart resource management. The service network domain entity of the SUN may perform a smart operation of managing a corresponding content through analysis of content-related information. Last, the service network domain entity of the SUN provides an opened programmability capability that may assist facilitating generation and application of the service and the application.

End User Domain Entity

The end user domain entity of the SUN performs an operation for ubiquitous connection. Herein, the ubiquitous connection operation of the end user domain entity means an operation for the end user domain entity to communicate with any device whenever and wherever, which includes a sensor network for a specific application (for example, a smart city, a smart building, a smart home network, or an e-health network). In order to support the ubiquitous connection operation, the end user device (that is, the end user domain entity) includes an ontology repository so as to report context information for context awareness of the SUN and further facilitate connection and transport of the service. Consequently, end users under the SUN environment reduce a significant amount of intervention due to arbitrary smart communication at the time of using a service and an application which benefit from a context awareness capability and a content awareness capability of the SUN.
As described above, the smart ubiquitous network (SUN) acquires static state information and dynamic state information from each domain entity. The SUN forms the network by using the acquired information and supports the smart function by a context awareness function to generate various statistical information required to provide the service. Meanwhile, each domain entity may configure each repository for the context information. The related information may be transported to and gathered (stored) in a context repository for analysis to be used, which takes an appropriate action for supporting the core capabilities of the SUN.

Hereinafter, a use case of the smart ubiquitous network according to the present invention will be described.

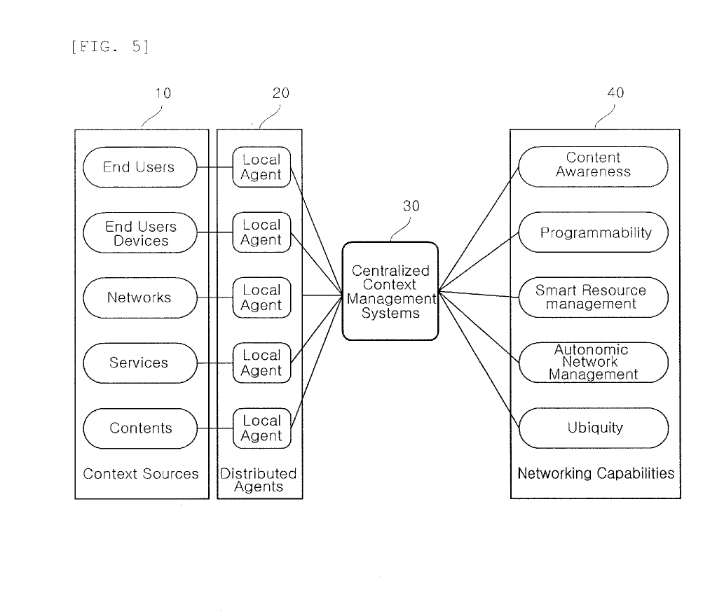

For example, it is assumed that as a smart communication scenario, knowledge about a state acquired from a health record of the end users (for example, the driver, both passengers (that is, passengers A and B), and the vehicle) and the information related from the accident is required. To this end, a predetermined situation occurs, and context sources associated with the following situation are defined so that information on the situation, which occurs, is formed (or processed) as knowledge information. A function of acquiring, exchanging, analyzing, and applying context information associated with a predetermined situation, which occurs, needs to be performed in extended networking of the SUN, from each resource (or an entity or an element) which is defined as described below. Referring to FIG. 5, a function and an operation of each context source will be described below.
End user information is a predetermined information or a dynamic status information from the end users regarding a state (for example, a location, a situation such as the traffic accident while driving, and the like) of the end user in order to support adaptive and automatically programmable service transport.
End user device information is a predetermined information or a dynamic status information from the end user device regarding a state of the end user device connected in order to support an adaptive and automatically programmable network, a connection configuration, and service transport.
Network information is a predetermined information or a dynamic status information from the network regarding a state (for example, states of a node and a traffic) of the network for supporting an adaptive and automatically programmable network.
Service information is a predetermined information or a dynamic status information from a service regarding states (for example, a service operation, and states and environment setting of a server and a storage) related to providing a service for supporting a configuration of an adaptive and automatically programmable service.
Content information is a predetermined information or a dynamic status information from the content regarding contents (for example, a media format, fusibility, an attribute, and the like) related with the content.

FIG. 5 is a block diagram illustrating a method of supporting another networking operation by using a situation awareness operation in a centralized context management system by using information received from five situation awareness resources (or sources) according to the present invention. A block disclosed in FIG. 5 includes a context source 10, a distribution agent 20, a centralized context management system 30, and a networking operation 40.

As illustrated in FIG. 4, the context source may be divided into five sources. That is, the five distributed context sources include a context source from the end user, a context source from the end user device, a context source from the network, a context source from the service, and a context source from the content. The centralized context management system 30 considers information acquired from the five context sources. That is, information acquired from each of the distributed context sources is stored in each corresponding local agent and/or transported directly to the centralized context management system. The received context information is transported to the corresponding network entity in order to be used for a related networking operation after processes such as context analysis and deduction (herein, a detailed description for a detailed function of the context awareness capability described with reference to FIG. 2 is applied to the detailed processes such as the context analysis and deduction) in the centralized context management system.

Meanwhile, the centralized context management system 30″ may support five context awareness based networking operations by using dynamically changed context information (for example, information acquired from each context source of FIG. 5). Hereinafter, referring to FIG. 5, the five context awareness based networking operations supported by the centralized context management system will be described.
A context aware content delivery capability is one networking operation based on context awareness supported by the centralized context management system, and is a function for the centralized context management system to know a current situation of the user and transport a content associated therewith. The context aware content delivery capability is a networking operation based on context awareness through which the centralized context management system performs accurate deduction by securing main information of a context and matching the secured information with another context information in order to transport the content, and searches and integrates the content to be transported. Meanwhile, the “context aware content delivery” may be configured by a so-called “context aware content delivery module” in which an operation or a function to perform the corresponding function is computer-programmed, and the configured “context aware content delivery module” may be implemented by one component included in the centralized context management system.
A context aware programmability capability is one networking operation based on context awareness supported by the centralized context management system, and the centralized context management system performs an on demand programming function for service configuration depending on context and policy information dynamically updated from a lower network and each service request. In particular, based on the context aware programmability function, the network is more efficiently and flexibly used and extensible management of the network should be supported to be arbitrarily operated. Meanwhile, the “context aware programmability” may be configured by a so-called “context aware programmability module” in which an operation or a function to perform the corresponding function is computer-programmed, and the configured “context aware programmability module” may be implemented by one component included in the centralized context management system.
A context aware smart resource management capability is one networking operation based on context awareness supported by the centralized context management system, and is a function that becomes aware of a change in a network situation considering an aspect of a quality of service (QoS) in various services (herein, the service includes a platform) depending on the policy and the service scenario. In particular, to this end, the context aware smart management capability is a function that performs smart allocation of the network resource through exchanging the context information with another network entity. Meanwhile, the “context aware smart resource management” may be configured by a so-called “context aware smart resource management module” in which an operation or a function to perform the corresponding function is computer-programmed, and the configured “context aware smart resource management module” may be implemented by one component included in the centralized context management system.
A context aware automatic network management capability is one networking operation based on context awareness supported by the centralized context management system, and is a function that becomes aware of a defect by adapting the network to a dynamic situation of the network by managing and monitoring the network through a very economical method without intervention of a person, and diagnoses and solves the defect. Meanwhile, the “context aware automatic network management” may be configured by a so-called “context aware automatic management module” in which an operation or a function to perform the corresponding function is computer-programmed, and the configured “context aware automatic network management module” may be implemented by one component included in the centralized context management system.
A context aware ubiquity (mobility) capability is one networking operation based on context awareness supported by the centralized context management system. The context aware ubiquity capability is a function that dynamically secures context information of a mobile entity in order to enable seamless automatic switching between different access technologies and services, and determines a most suitable connection option at a given time by using the same. Meanwhile, the “context aware ubiquity” may be configured by a so-called “context ubiquity module” in which an operation or a function to perform the corresponding function is computer-programmed, and the configured “context aware ubiquity module” may be implemented by one component included in the centralized context management system.

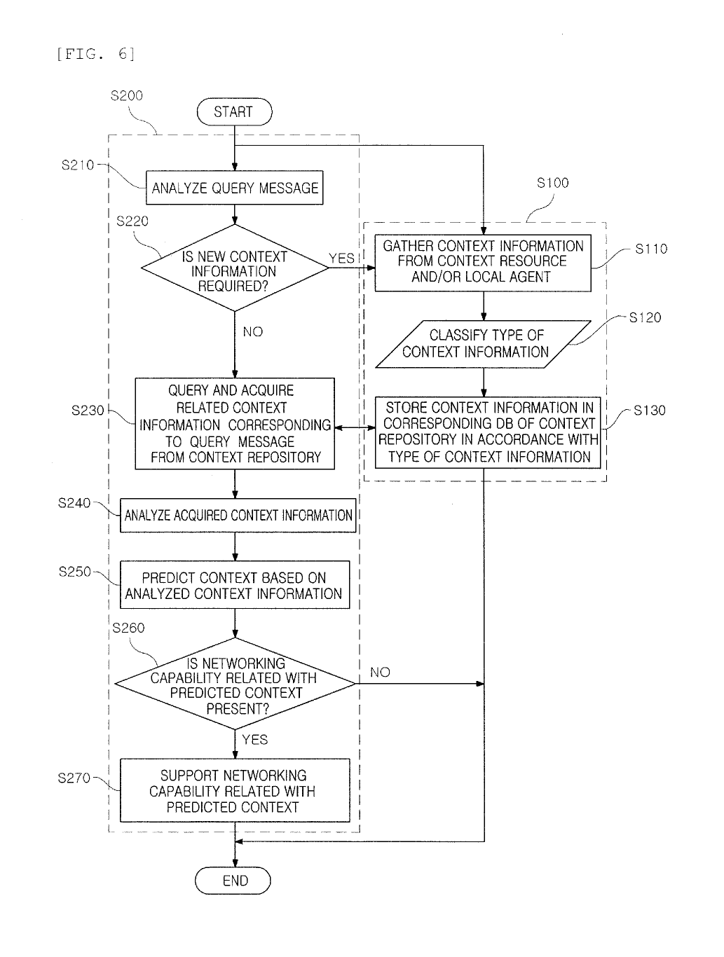

FIG. 6 is a flowchart illustrating an operation of analyzing dynamic context information and applying the analyzed dynamic context information to a smart ubiquitous networking operation in the centralized context management system according to the present invention.

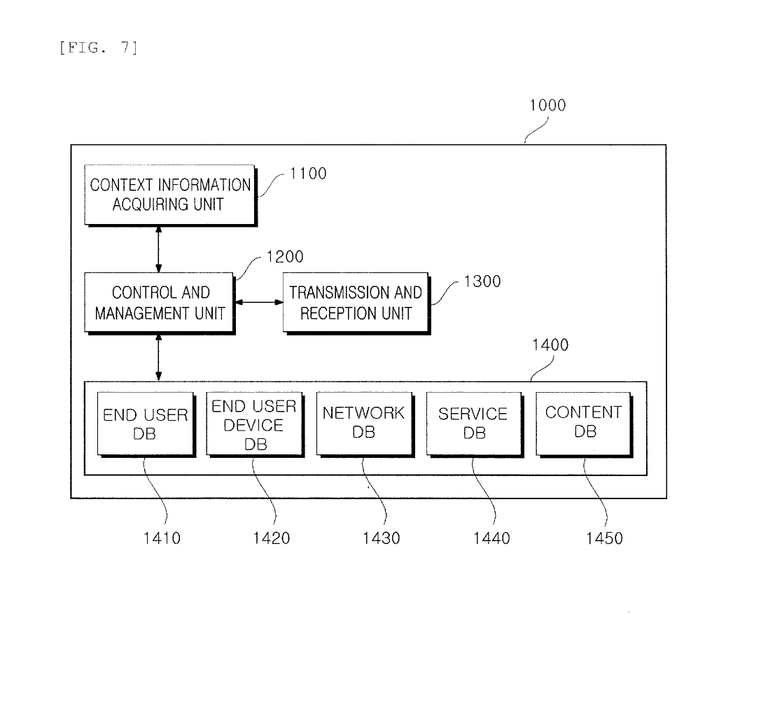

FIG. 7 is one example of a block diagram of the central context management system according to the present invention. FIG. 7 schematically illustrates the components of the centralized context management system described with reference to FIG. 6. However, physical components illustrated in FIG. 7 are just schematically illustrated in order to describe a concept of the exemplary embodiment of the present invention in brief. The components of the centralized context management system according to the present invention include all of the essential software and hardware components (for example, includes an input unit such as a keyboard or a mouse, an output unit such as a display or a speaker, and the like) required to appropriately implement the exemplary embodiment of the present invention, in addition to the components of FIG. 7. Names of the components of FIG. 7 are just defined in order to describe the exemplary embodiment of the present invention and functions and operations of the names are not limited.

Hereinafter, the function and operation of the centralized context management system according to the present invention will be described with reference to FIGS. 6 and 7.

As illustrated in FIG. 6, the operation of the centralized context management system is generally divided into dynamically acquiring context information from each context source (that is, for example, each context source of FIG. 5) and storing the context information in a context repository (alternatively, a storage unit) (S100), and receiving, and analyzing and deducing, by the centralized context management system, a query message for performing a specific service and networking operation, and supporting five context awareness networking operations with a corresponding network entity in order to support the corresponding networking operation (S200). Hereinafter, the steps (that is, S100 and S200) will be described in detail with reference to FIGS. 5 and 6.

As illustrated in FIG. 5, the centralized context management system (may be, for example, ‘a context information acquiring unit’ of the centralized context management system) dynamically acquires (alternatively, updates) the context information from five respective context sources and/or the corresponding local agent of each context source (S110). The centralized context management system (may be, for example, a ‘control and management unit’ of the centralized context management system) classifies a type of the acquired context information (S120).

The centralized context management system (may be, for example, the ‘control and management unit’ of the centralized context management system) stores the acquired context information in a corresponding database (DB) of the context repository (alternatively, storage unit) depending on a type of the classified context information (S130).

Herein, the context repository may include an ‘end user DB’, an ‘end user device DB’, a ‘network DB, a ‘service DB’, and a ‘content DB’ depending on a type of the context information, and has related ontology as necessary.

Hereinafter, a series of steps S200 will be described.

When the centralized context management system (may be, for example, a ‘transmission and reception unit’ of the centralized context management system) receives the query message for performing the specific service and networking operation, the centralized context management system (may be, for example, the ‘control and management unit’ of the centralized context management system) analyzes the received query message (S210). It is checked (or judged) whether new context information is required from the analyzed query message (S220). If it is judged that the new context information is required in step (S220), step S110 is performed, and thereafter, steps S120 and S130 will be performed.

Meanwhile, if it is judged that the new context information is not required in step S220, context information dynamically updated from each context source and/or each local agent or existing related context information in the context repository is acquired (S230). The centralized context management system (may be, for example, the ‘control and management unit’ of the centralized context management system) performs context analysis and context deduction (or prediction) functions based on the acquired context information (S240 and S250). The centralized context management system (may be, for example, the ‘control and management unit’ of the centralized context management system) judges what a networking operation, to which the context information analyzed and predicted in the steps (that is, S240 and S250) will be applied, is (S260). The centralized context management system (may be, for example, the ‘control and management unit’ of the centralized context management system) transports five context awareness based networking operations to the corresponding network entity for supporting the networking operation related with the judgment based on five context awareness, based on the judgment of step S260, thereby supporting the networking operation to the corresponding network entity (S270). In this case, the five context awareness based networking operations include “the context aware content delivery capability”, “the context aware programmability capability”, “the context aware smart resource management capability”, “the context aware automatic network management capability”, and “the context aware ubiquity (mobility) capability”, as described in FIG. 5.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A method for providing a context awareness based networking operation, comprising:
receiving a query message for performing a specific service and networking operation;
acquiring context information related with the analyzed query message;
performing context analysis and context prediction based on the acquired context information;
judging a networking operation to which the analyzed and predicted context information is to be applied; and
transporting a context awareness based networking operation to a corresponding network entity in order to support the networking operation related with the judgment, based on the judgment of the networking operation to be applied.

2. The method of claim 1, further comprising:
dynamically acquiring context information from a plurality of context sources and/or a corresponding local agent of each context source;
classifying a type of the acquired context information; and
storing the acquired context information in a corresponding database (DB) of a context repository in accordance with the type of the classified context information.

3. The method of claim 2, wherein the context repository includes:
an ‘end user DB’, an ‘end user device DB’, a ‘network DB’, a ‘service DB’, and a ‘content DB, and
the classified context information is stored in any one of the DBs in accordance with the type of the context information.

4. The method of claim 3, wherein the context repository further includes related ontology in accordance with the type of the context information.

5. The method of claim 1, wherein in the acquiring of the context information related with the analyzed query message,
the related context information is acquired from an existing specific database (DB) of the context repository, and
the related context information is dynamically updated from the plurality of context sources and/or the plurality of local agents to be stored in the specific DB of the context repository.

6. The method of claim 1, wherein in the transporting of the context awareness based networking operation, the context awareness based networking operation includes “a context aware content delivery capability”, “a context aware programmability capability”, “a context aware smart resource management capability”, “a context aware automatic network management capability”, and “a context aware ubiquity capability”.

7. The method of claim 6, wherein the context aware content delivery capability is a networking operation that performs a function to know a current context of a user and transport a related content in accordance therewith.

8. The method of claim 6, wherein the context aware programmability capability is a networking operation that performs an on demand programming function for a service configuration depending on dynamically updated context and policy information from a lower network and each service request.

9. The method of claim 6, wherein the context aware smart resource management capability is a networking operation that performs a function to be aware of a change in a network context considering an aspect of a quality of service (QoS) in various services depending on a policy and a service scenario and perform smart allocation of a network resource by exchanging context information with another network entity.

10. The method of claim 6, wherein the context aware automatic network management capability is a networking operation that performs a function to be aware of a defect by adapting the network to a dynamic situation of the network by managing and monitoring the network using a very economical method without intervention of a person, and diagnose and solve the defect.

11. The method of claim 6, wherein the context aware ubiquity (mobility) capability is a networking operation that performs a function to dynamically secure context information of a mobile entity in order to enable seamless automatic switching between different access technologies and services, and determine a most suitable connection option at a given time by using the same.

12. A context management system that provides a context awareness based networking operation, comprising:
a control and management unit that
acquires context information from a repository, and analyzes and predicts the acquired context information,
judges a corresponding networking operation to which the analyzed and predicted context information is to be applied; and
transports a context awareness based networking operation which is related, to a network entity based on the judgment.

13. The system of claim 12, wherein the control and management unit classifies a type of the context information acquired by a context information acquiring unit and
stores the acquired context information in a corresponding database of a context repository in accordance with the type of the classified context information.

14. The system of claim 12, further comprising:
a context information that acquires unit dynamically acquiring context information from at least one context source and/or a corresponding local agent of each context source;
a context repository in which the acquired context information is stored in accordance with the type of the context information; and
a transmission and reception unit that receives a query message for performing the specific service and networking operation.

15. The system of claim 14, wherein the context repository includes an ‘end user DB’, an ‘end user device DB’, a ‘network DB’, a ‘service DB’, and a ‘content DB’, and the acquired context information is stored in the corresponding DB in accordance with the type of the context information.

16. The system of claim 12, wherein the context awareness based networking operation includes “a context aware content delivery capability”, “a context aware programmability capability”, “a context aware smart resource management capability”, “a context aware automatic network management capability”, and “a context aware ubiquity capability.
